(19) United States
(12) Patent Application Publication
(10) Pub. No.: US 2010/0302675 A1
(43) Pub. Date: Dec. 2, 2010

(54) STORAGE MEDIUM AND METHOD AND PROGRAM FOR DETECTING TRACK POSITION OF STORAGE MEDIUM

(75) Inventors: Tatsuhiko KOSUGI, Tokyo (JP); Takeshi HARA, Tokyo (JP); Hiroaki MAEKAWA, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Toshiba Storage Device Corporation, Tokyo (JP)

(21) Appl. No.: 12/788,223

(22) Filed: May 26, 2010

(30) Foreign Application Priority Data
May 26, 2009 (JP) 2009-125983

(51) Int. Cl. G11B 5/82; G11B 5/596

(52) U.S. Cl. 360/77.02; 360/135; G9B/5.293; G9B/5.216

(57) ABSTRACT

According to one embodiment, a storage medium that stores position information indicating positions of a plurality of tracks in a radial direction in the tracks, wherein the position information includes: a first pattern in which a feed angle indicating a phase difference between the tracks is an angle obtained by adding a predetermined angle to +90°; a second pattern in which the feed angle is an angle obtained by adding the predetermined angle to −90°; and a third pattern in which the feed angle is the same as that of the first pattern.

### CROSS-REFERENCE TO RELATED APPLICATIONS

This application is based upon and claims the benefit of priority from Japanese Patent Application No. 2009-125983, filed May 26, 2009, the entire contents of which are incorporated herein by reference.

### BACKGROUND

1. Field

One embodiment of the invention relates to a storage medium that stores position information indicating positions of tracks in a radial direction in the tracks and a track position detecting method of the storage medium and a computer program product having a computer readable medium including programmed instructions for detecting a track position of the storage medium.

2. Description of the Related Art

In general, a storage medium, such as a hard disk drive (HDD), which has a plurality of tracks concentrically, has a plurality of servo patterns in each track equidistantly. Each of the servo patterns indicates a position in the radial direction of the track. A storage device, such as a personal computer (PC), which has the storage medium, controls a head using a voice coil motor (VCM) control and reads the servo pattern to detect a position of the track. By detecting the position of the track, a head position in the track can be detected and the head can move to a target track. For example, the servo pattern has four burst signal areas where burst signals are read by the head. Since in the servo pattern the four burst signal areas are used to detect the position of the track in the radial direction, the length of the servo pattern (length of a circumferential direction in the storage medium) is long.

As related technologies, a technology for increasing an information storage capacity of a storage medium and a technology for improving flatness of a storage medium are provided (for example, Japanese Patent Application Publication (KOKAI) No. 2000-90609, Japanese Patent Application Publication (KOKAI) No. 2006-120299, and Japanese Patent Application Publication (KOKAI) No. 2008-171513).

A storage area where user data is stored is provided between adjacent servo patterns. For this reason, when the length of the servo pattern is long, the storage area of the user data is narrowed and the storage capacity is reduced.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view of a servo pattern of a storage medium according to an embodiment of the invention;

FIG. 2 is an exemplary view of a format configuration of the servo pattern in the storage medium in the embodiment;

FIG. 3 is an exemplary diagram of position areas in the embodiment;

FIG. 4 is an exemplary view of signal patterns of the position areas even1 and even2 to which dithering is not applied;

FIG. 5 is an exemplary view of signal patterns of position areas even1 and even2 to which dithering is applied in the embodiment;

FIG. 6A is an exemplary graph illustrating a relationship between an actual cylinder position and a demodulation position, when dithering is not applied to each position area;

FIG. 6B is an exemplary graph illustrating a relationship between an actual cylinder position and a demodulation position, when dithering is applied to each position area in the embodiment;

FIG. 7 is an exemplary view of a signal pattern of a position area odd1 to which dithering is applied in the embodiment;

FIG. 8 is an exemplary block diagram of a storage device that has the storage medium in the embodiment;

FIG. 9 is an exemplary functional block diagram of the storage device that has the storage medium in the embodiment;

FIG. 10 is an exemplary flowchart of processes in a track position detecting method of the storage medium in the embodiment;

FIG. 11 is an exemplary diagram of a demodulating process in the embodiment;

FIG. 12 is an exemplary diagram of another odd demodulating method in the embodiment;

FIG. 13 is an exemplary view of a mirror image of a vector in the embodiment;

FIG. 14A is an exemplary view of rotation of an odd vector by a first synthesis in the embodiment;

FIG. 14B is an exemplary view of a first synthesis result in the embodiment;

FIG. 15A is an exemplary view of an odd demodulation result with respect to an angle in the embodiment;

FIG. 15B is an exemplary view of a fine demodulation result with respect to the angle in the embodiment;

FIG. 15C is an exemplary view of a result with respect to the angle that is obtained by subtracting the angle indicating the fine demodulation result from the angle indicating the odd demodulation result in the embodiment;

FIG. 16A is an exemplary view of rotation of a coarse vector by a second synthesis in the embodiment;

FIG. 16B is an exemplary view of a second synthesis result in the embodiment;

FIG. 17A is an exemplary view of a coarse demodulation result with respect to an angle in the embodiment;

FIG. 17B is an exemplary view of an odd demodulation result with respect to the angle in the embodiment;

FIG. 17C is an exemplary view of a result with respect to the angle that is obtained by subtracting the angle indicating the odd demodulation result from the angle indicating the coarse demodulation result in the embodiment;

FIG. 18 is an exemplary diagram of position areas where a feed angle is different in the embodiment;

FIG. 19 is an exemplary diagram of position areas of a storage medium where technology disclosed in the present application is not applied; and

FIG. 20 is an exemplary view of a computer system where the technology disclosed in the present application is applied.

### DETAILED DESCRIPTION

Various embodiments according to the invention will be described hereinafter with reference to the accompanying drawings. In general, according to one embodiment of the invention, a storage medium that stores position information indicating positions of a plurality of tracks in a radial direction in the tracks, wherein the position information includes: a first pattern in which a feed angle indicating a phase difference between the tracks is an angle obtained by adding a predetermined angle to +90°; a second pattern in which the feed angle is an angle obtained by adding the predetermined angle to −90°; and a third pattern in which the feed angle is the same as that of the first pattern.

According to another embodiment of the invention, a track position detecting method of a storage medium that stores position information indicating positions of a plurality of tracks in a radial direction in the tracks, the track position detecting method comprising: acquiring first phase information from a first pattern of the position information in which a feed angle indicating a phase difference between the tracks is an angle obtained by adding a predetermined angle to +90°; acquiring second phase information from a second pattern of the position information in which the feed angle is an angle obtained by adding the predetermined angle to −90°; acquiring third phase information from a third pattern of the position information in which the feed angle is the same as that of the first pattern; and performing demodulation using the first, second, and third phase information to detect a position of the track.

According to still another embodiment of the invention, a computer program product having a computer readable medium including programmed instructions for detecting a track position of a storage medium that stores position information indicating positions of a plurality of tracks in a radial direction in the tracks, wherein the instructions, when executed by a computer, cause the computer to perform: acquiring first phase information from a first pattern of the position information in which a feed angle indicating a phase difference between the tracks is an angle obtained by adding a predetermined angle to +90°; acquiring second phase information from a second pattern of the position information in which the feed angle is an angle obtained by adding the predetermined angle to −90°; acquiring third phase information from a third pattern of the position information in which the feed angle is the same as that of the first pattern; and performing demodulation using the first, second, and third phase information to detect a position of the track.

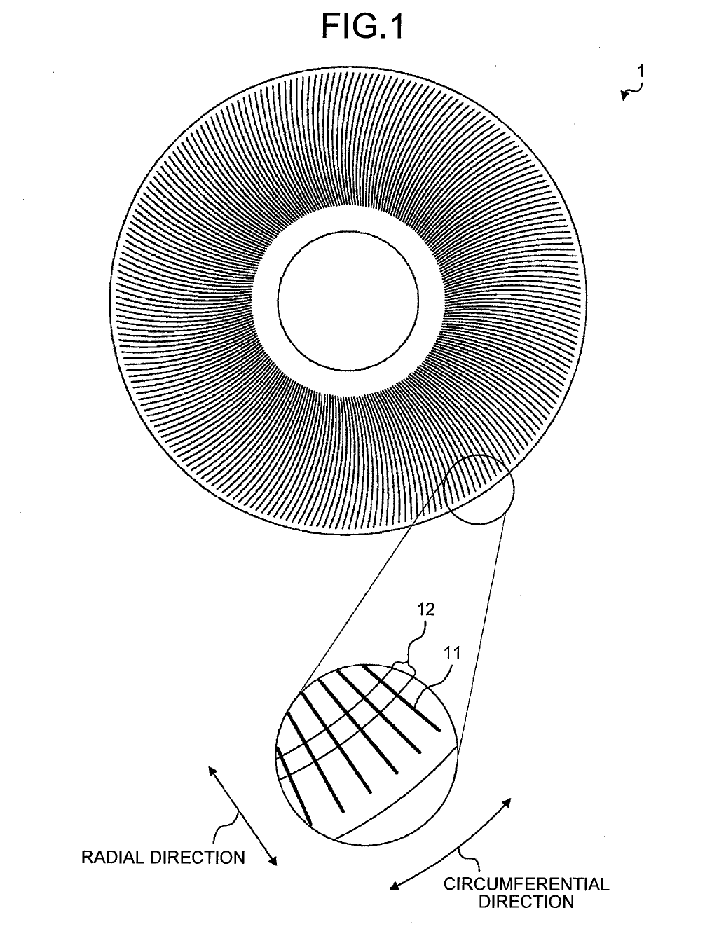

One embodiment according to the invention will be described hereinafter with reference to the accompanying drawings. FIG. 1 illustrates a servo pattern of a storage medium according to the embodiment of the invention. As illustrated in FIG. 1, in a storage medium 1, a plurality of servo patterns 11 that extend in a radial direction from a center of the storage medium 1 are equidistantly provided in a circumferential direction by an embedded servo method, for example. In the storage medium 1, a plurality of tracks 12 are provided concentrically, and the servo patterns 11 are stored in the tracks 12 and indicate positions of the tracks 12 in the radial direction. According to this configuration, a position of a head (to be descried below) on the track can be detected by using the servo patterns 11. A storage area in which user data, for example, is stored is provided between the adjacent servo patterns 11. The storage medium 1 has a plurality of layers laminated at a regular interval, and the track 12 is called as a cylinder. The storage medium 1 may have a single layer.

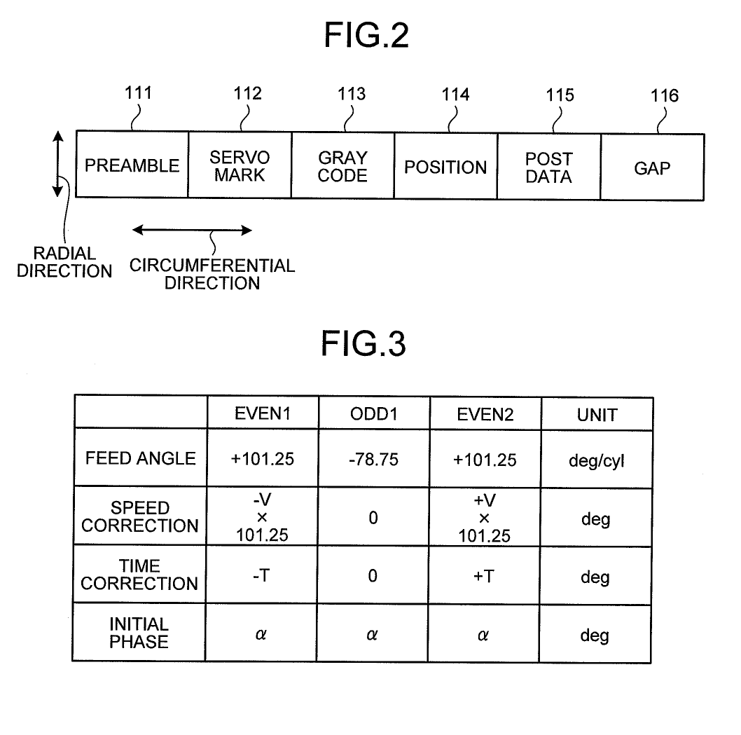

FIG. 2 illustrates a format configuration of the servo pattern in the storage medium in the embodiment. As illustrated in FIG. 2, a format of the servo pattern 11 has a preamble 111, a servo mark 112, a gray code 113, a position 114, post data 115, and a gap 116. The preamble 111 indicates so-called a gap that separates the storage area of the user data and the servo pattern 11. The servo mark 112 indicates a start of the servo pattern 11. The gray code 113 has a cylinder number and a head number, for example that are numerical values. The position 114 is so-called a burst signal area that has position information of the cylinder in the radial direction, which will be described in detail below. The post data 115 has a Repetitive Run out (RRO) correction value that is a numerical value. The gap 116 separates the servo pattern 11 and the storage area of the user data.

The position 114 has areas indicating three burst signals that are position areas even1, odd1, and even2 in which signal patterns are written, respectively. The signal patterns have phases that are read as the burst signals by the head to be described below. When each position area is read by the head, the position information of the cylinder in the radial direction can be detected. Accordingly, since the position information of the cylinder in the radial direction can be detected by using each position area, the position of the head in the cylinder can be detected.

The position areas are be explained with reference to FIG. 3. A feed angle illustrated in FIG. 3 indicates a phase difference between the cylinders. That is, the feed angle is an angle of a phase that varies for every cylinder in the signal pattern of each position area, and a unit thereof is deg/cyl. Because the head crosses each position area at a predetermined speed by a seek operation in which the head is moved by a VCM to be described below, a speed correction is performed to correct a variation in the angle of the phase generated due to the predetermined speed. V indicates a speed correction component. A time correction is performed to correct a variation in the phase angle generated due to accumulation of a variation in a clock needed when a Discrete Fourier Transform (DFT) is performed. T indicates a time correction component. An initial phase in each position area is a. Each unit of the speed correction, the time correction, and the initial phase is deg.

The position area even1 has a feed angle of +101.25 deg/cyl. This indicates that a phase of a signal pattern becomes 0° in a cylinder 0 as a reference cylinder, a phase becomes 101.25° in a cylinder 1, and a phase becomes 202.5° in a cylinder 2. Likewise, the position area odd1 has a feed angle of −78.75 deg/cyl. This indicates that a phase of a signal pattern becomes 0° in a cylinder 0 as a reference cylinder, a phase becomes −78.75° in a cylinder 1, and a phase becomes −157.5° in a cylinder 2. Since the position area even2 has the same feed angle as that of the position area even1, the description thereof will be omitted.

Each position area has the above-described feed angle. If a demodulation is performed using each position area, linearity of ±8 cylinders can be obtained. This is because, if a calculation of adding a phase of the position area odd1 to a phase of the position area even1 or even2 is performed by coarse demodulation to be described below, a phase of 0° is calculated in the cylinder 0 but a phase of +101.25°+(−78.75°) is calculated in the cylinder 1, and a phase difference of 22.5° can be obtained. If the phase of one cylinder is represented by 22.5°, the phase of 16 cylinders can be represented by 360°. As a result, a position of a target cylinder can be detected in a wide range of ±8 cylinders. Since each position area has the above-described feed angle, even though a shock is applied at a time of the seek operation with respect to the target cylinder and variation corresponding to 8 cylinders is generated in the position of the head, seek of the head to the target cylinder is enabled.

Since each position area has the above-described feed angle, linearity of ±1 cylinder can be obtained, when the demodulation is performed using each position area. This is because, if a calculation of even-odd is performed by fine demodulation to be described below, a phase of 0° is calculated in the cylinder 0 but a phase of +101.25° -)(−78.75° is calculated in the cylinder 1, and a phase difference of 180° can be obtained. Because the phase of one cylinder is represented by 180°, the phase of the two cylinders can be represented by 360°. As a result, the position of the target cylinder can be detected in a fine range of ±1 cylinder. The feed angles of the position areas are not limited to the above feed angles, and may have feed angles where a difference between the feed angle of each of the position areas even1 and even2 and the feed angle of the position area odd1 becomes +180°. The feed angles of the position areas may have feed angles where a sum of the feed angle of each of the position areas even1 and even2 and the feed angle of the position area odd1 becomes −22.5° or +22.5°

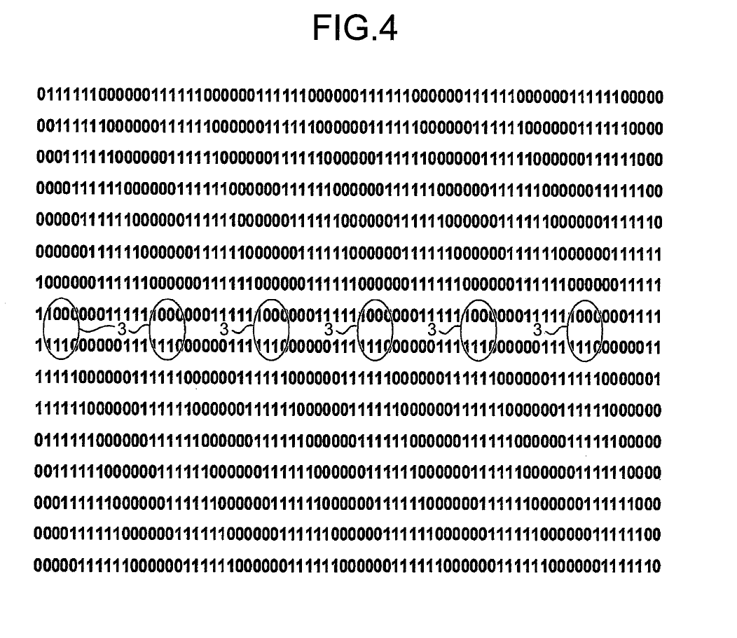

Dithering is applied to the signal pattern of each position area such that a demodulation position corresponding to the position of the cylinder calculated based on each phase, using a phase demodulating method to be described below is similar to the actual position of the cylinder on the storage medium 1 corresponding to the demodulation position (hereinafter, referred to as “actual cylinder position”). By applying the dithering, the signal pattern of each position area has a zigzag pattern that has patterns of five clocks to be described below in all directions. For example, if the dithering is not applied to the position areas even1 and even2, as illustrated in FIG. 4, discontinuous places 3 where the signal patterns are discontinuous are generated. Similarly, this situation is applicable to the position area odd1. If the feed angle of each position area has a round number such as +90° or −90°, a pattern where a signal pattern is not discontinuous can be formed at the time of Servo track writing (STW). However, since the feed angle of each position area is +101.25° or −78.75° that is obtained by adding +11.25° or −11.25° to +90° or −90°, the signal pattern becomes discontinuous. The feed angles +11.25° and −11.25° are ±½ values of 22.5° that is an angle to detect the position of the target cylinder in the range of ±8 cylinders.

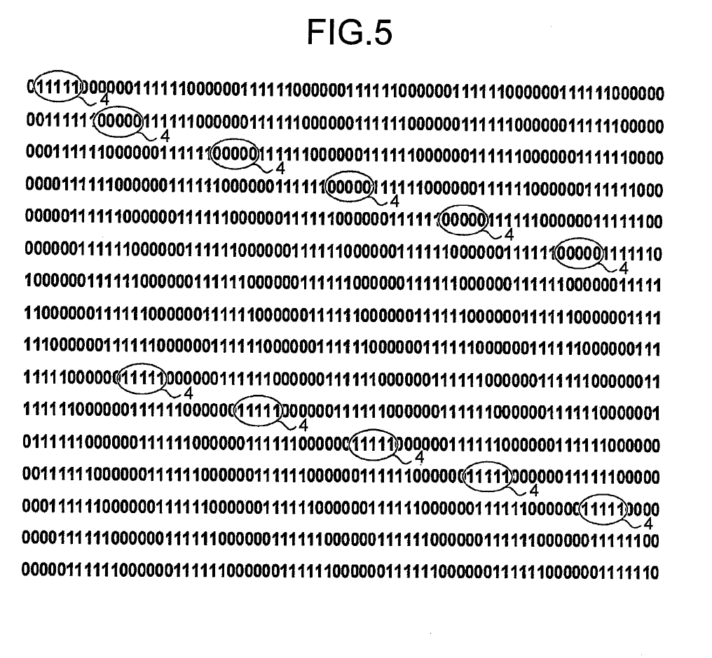

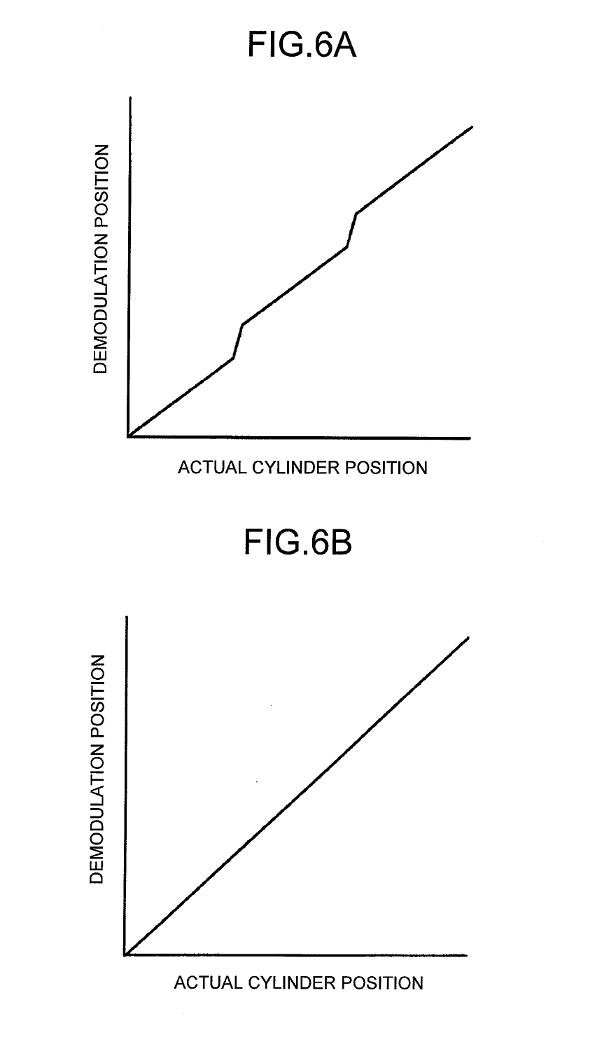

Meanwhile, when the dithering is applied, the signal patterns of the position areas even1 and even2 become the state where patterns 4 of five clocks like 00000 or 11111 illustrated in FIG. 5 are provided in all directions. FIG. 6A illustrates a relationship between the actual cylinder position and the demodulation position, when the dithering is not applied to each position area. FIG. 6B illustrates a relationship between the actual cylinder position and the demodulation position, when the dithering is applied to each position area. As illustrated in FIG. 6A, when the dithering is not applied, a slope of a line indicating the relationship between the actual cylinder position and the demodulation position varies at the discontinuous place 3. For this reason, the relationship between the actual cylinder position and the demodulation position does not become linearity but becomes so-called non-linearity (position non-linearity). Meanwhile, as illustrated in FIG. 6B, when the dithering is applied, the relationship between the actual cylinder position and the demodulation position becomes approximately linearity, and linearity can be (position linearity) can be obtained.

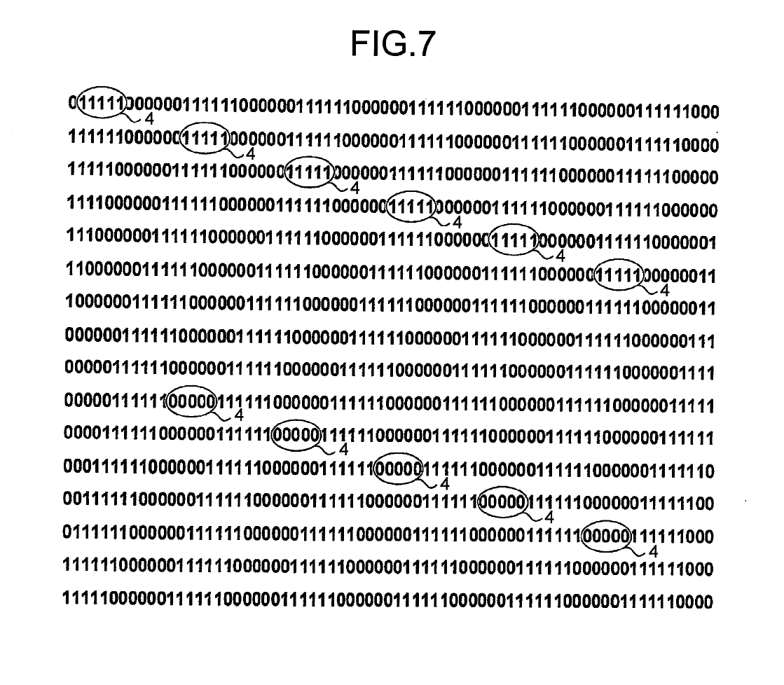

The position areas even1 and even 2 are described above, but the dithering is similarly applied to the position area odd1. FIG. 7 illustrates a signal pattern of the position area odd1 to which the dithering is applied. As illustrated in FIG. 7, the signal pattern of the position area odd1 also has patterns 4 of five clocks in all directions. In the above cases, the signal pattern of each position area has the patterns 4 of five clocks, but the invention is not limited thereto. For example, the signal pattern of each position area may have patterns of the number of clocks such that the relationship between the actual cylinder position and the demodulation position becomes linearity.

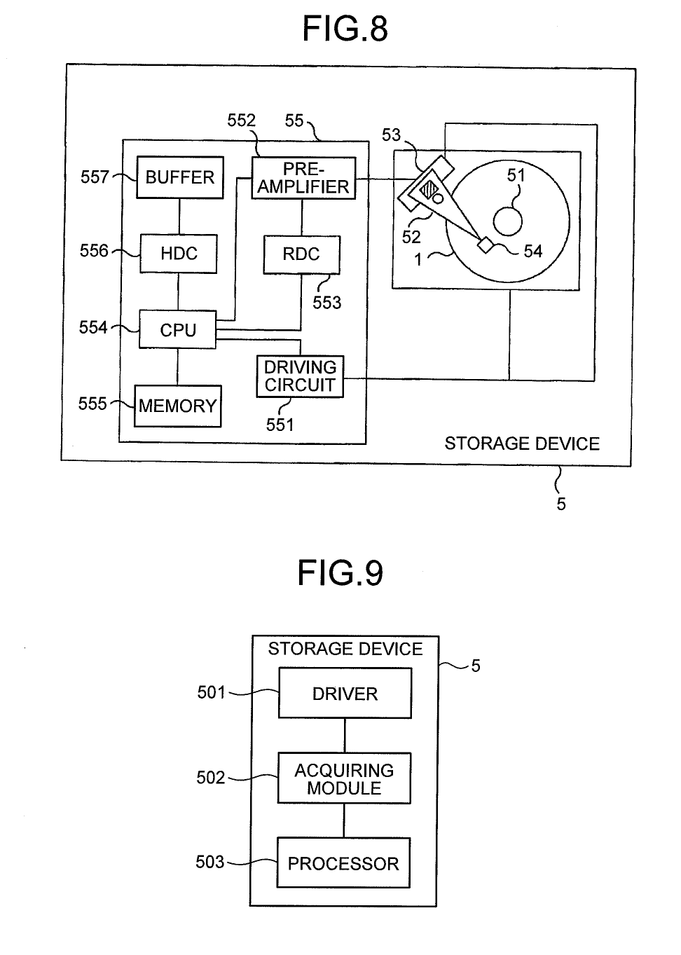

Next, a track position detecting method executed by a storage device having the storage medium according to the embodiment will be described. FIG. 8 is a block diagram of a storage device having the storage medium. As illustrated in FIG. 8, a storage device 5 includes the storage medium 1, a spindle motor (SPM) 51, a head actuator 52, a VCM 53, a head 54, and a controller 55.

The SPM 51 rotationally drives the storage medium 1. The head actuator 52 is an arm that is disposed on the VCM 53 and supports the head 54 held on an end of the head actuator 52. The VCM 53 drives the head actuator 52 and performs seek of the head 54, and so on. The head 54 acquires phase information from each position area in the storage medium 1, reads data stored in the storage medium 1, and writes data into the storage medium 1. The controller 55 performs SPM control to control the SPM 51 and VCM control to control the VCM 53, and executes the track position detecting method to be described below. The controller 55 has a driving circuit 551, a preamplifier 552, a read/write channel (RDC) 553, a central processing unit (CPU) 554, a memory 555, a hard disk controller (HDC) 556, and a buffer 557.

The driving circuit 551 rotationally drives the SPM 51 and drives the VCM 53. The preamplifier 552 amplifies a signal read from the storage medium 1 by the head 54 and a signal written in the storage medium 1 by the head 54. The RDC 553 encodes information to be written in the storage medium 1 and decodes a signal that is read from the storage medium 1.

The CPU 554 controls the operations of the above configuration, and the memory 555 is a rewritable nonvolatile storage medium that stores programs and data, and so on. The HDC 556 corrects an error of data transmitted and received between the storage device 5 and an external device such as a host. The buffer 557 temporarily stores data to compensate for variation in timing of data input/output processing, generated when the data is transmitted and received between the HDC 556 and the external device.

FIG. 9 illustrates a functional block of the storage device that has the storage medium in the embodiment. As illustrated in FIG. 9, the storage device 5 has a driver 501 that rotationally drives the SPM 51 and drives the VCM, an acquiring module 502 that acquires the phase information as a vector by reading each position area, and a processor 503 that executes a phase demodulating process and a synthesizing process to be described below, based on the acquired vector, and detects the position of the cylinder. The above mentioned individual functions in the storage device 5 are realized when the CPU 554 reads the program stored in the memory 555 and the CPU 554 and the memory 555 cooperate with each other.

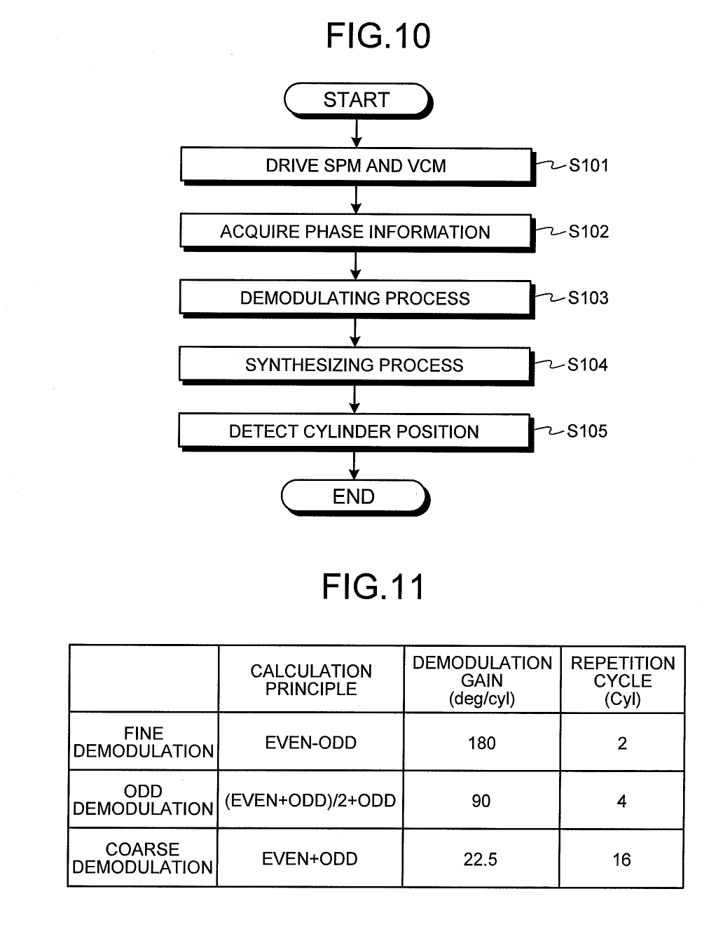

FIG. 10 is a flowchart of a track position detecting processing of the storage medium in the embodiment. First, if an instruction indicating that the position of the cylinder needs to be detected to read or write data, and so on is input to the storage device 5 by a user, the driver 501 starts to rotationally drive the SPM 51 and drive the VCM 53 with the driving circuit 551 (S101). After the driving starts, the acquiring module 502 acquires the phase information as the vector from each position area with the head 54 (S102). After the acquisition, the processor 503 executes the phase demodulating process based on the phase information (S103). After the phase demodulating process, the processor 503 executes the synthesizing process on the result of the phase demodulating process (S104). After the synthesizing process, the processor 503 detects the position of the cylinder based on the results of the phase demodulating process and the synthesizing process (S105), and this flow ends.

FIG. 11 illustrates the phase demodulating process. In FIG. 11, even indicates the vector of the position areas even1 and even2, and odd indicates the vector of the position area odd 1. The phase demodulating process is executed in the order of the fine demodulation, odd demodulation, and the coarse demodulation. The fine demodulation performs a calculation of even−odd, and its demodulation gain is 180 deg/cyl and its repetition cycle is 2 cyl. That is, the phase difference of 180° is obtained for each cylinder. For this reason, the phase difference of 360° is obtained by two cylinders. By this configuration, the position of the target cylinder can be detected in the range of ±1 cylinder. The odd demodulation performs a calculation of [(even+odd)/2]+odd, and its demodulation gain is 90 deg/cyl and its repetition cycle is 4 cyl. That is, the phase difference of 90° is obtained for each cylinder. For this reason, the phase difference of 360° is obtained by four cylinders. By this configuration, the position of the target cylinder can be detected in a range of ±2 cylinders. The coarse demodulation performs a calculation of even+odd, and its demodulation gain is 22.5 deg/cyl and its repetition cycle is 16 cyl. That is, the phase difference of 22.5° is obtained for each cylinder. For this reason, the phase difference of 360° is obtained by sixteen cylinders. By this configuration, the position of the target cylinder can be detected in the range of ±8 cylinders.

In this case, since the odd demodulation includes the coarse demodulation, the processor 503 performs the coarse demodulation before performing the odd demodulation, and performs the coarse demodulation again thereafter. Instead of performing the coarse demodulation again, the result of the temporary coarse demodulation may be used. In this case, the correction may be performed on the odd without performing the coarse demodulation before performing the odd demodulation, and the odd demodulation may be performed.

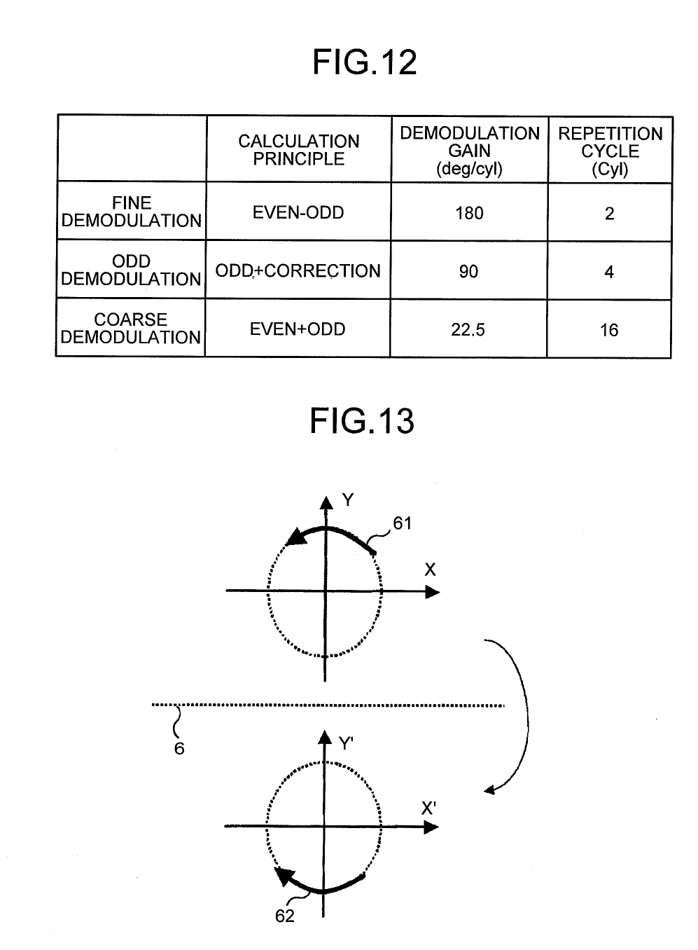

FIG. 12 illustrates another odd demodulating method. A correction illustrated in the calculation principle of the odd demodulation includes a correction using the gray code 113 and a correction using an estimation position. The estimation position indicates an estimated position of a cylinder where a vector is acquired, and is obtained by estimating the cylinder where the head 54 is positioned. The correction using the gray code 113 is a correction that enables acquisition of the same result as even+odd by applying 11.25° to a value of the cylinder number, because the cylinder number indicated by the gray code 113 increases by 1 for every cylinder. The correction using the estimation position is a correction that applies 11.25° to the cylinder number indicating the cylinder estimated as the cylinder where the head 54 is positioned, similar to the correction using the gray code 113.

The processor 503 performs a calculation using a mirror image of odd, such as odd reversely rotates, when the coarse demodulation is performed. That is, the processor 503 inverts the polarity of odd. This reason is as follows. In the vector addition of even+odd in the coarse demodulation, the vector length varies, and it is difficult to get a stable phase, when the synthesis vector is used. FIG. 13 illustrates a mirror image of a vector. As illustrated in FIG. 13, in order to use a vector 61 as a mirror vector 62 with respect to a reference line 6, the processor 503 sets Y′=−Y and inversely transform a Y axis component. In this way, the vector 61 becomes the mirror vector 62 having a reverse rotation direction. As a method that reversely rotates odd other than Y′=−Y, any one of X′=−X, X′=Y, and Y′=X maybe used. Alternatively, even may be reversely rotated, instead of reversely rotating odd.

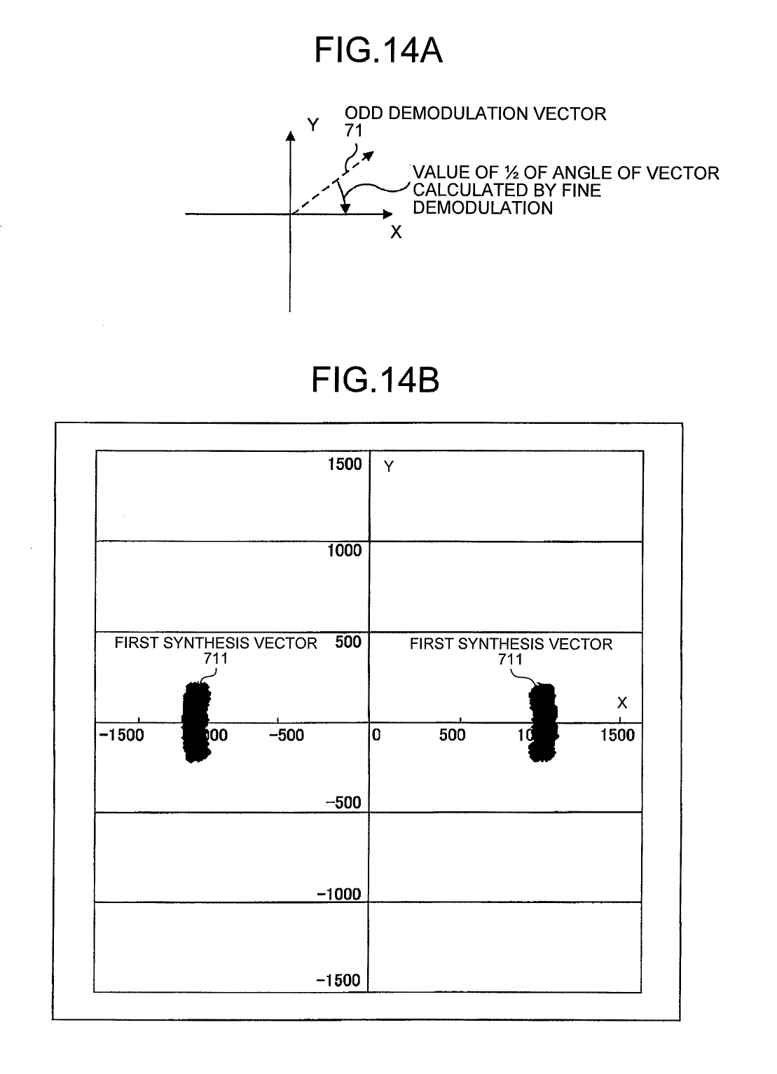

Next, the synthesizing process will be described. In the synthesizing process, the processor 503 performs a first synthesis that is a synthesis of a vector calculated by the odd demodulation and a vector calculated by the fine demodulation. After the first synthesis, the processor 503 performs a second synthesis that is a synthesis of a vector calculated by the coarse demodulation and a vector calculated by the fine demodulation or a vector calculated by the odd demodulation. The first synthesis is explained using the vectors calculated by the demodulations with reference to FIGS. 14A and 14B. As illustrated in FIG. 14A, the processor 503 sets a value of ½ of an angle of the vector calculated by the fine demodulation as a rotation operator and rotates an odd demodulation vector 71 calculated by the odd demodulation using the rotation operator. Thereby, as illustrated in FIG. 14B, a judging method using two quadrature vectors that separates the odd demodulation vector 71 into vectors in two quadratures of 0° and 180° is enabled, and the position of the target cylinder can be detected with precision in a range of ±2 cylinders. In FIG. 14B, a state where the first synthesis is performed a plurality of times is illustrated. In a first synthesis vector 711 obtained as the result of the first synthesis, angle differences exist in the two quadratures. This is because errors are generated in the angles of the first synthesis vector 711, even though the first synthesis is performed. However, even though the errors are generated, since the odd demodulation vector 71 is separated into angles approximated to 0° and 180°, the position of the target cylinder can be detected with precision in the range of ±2 cylinders.

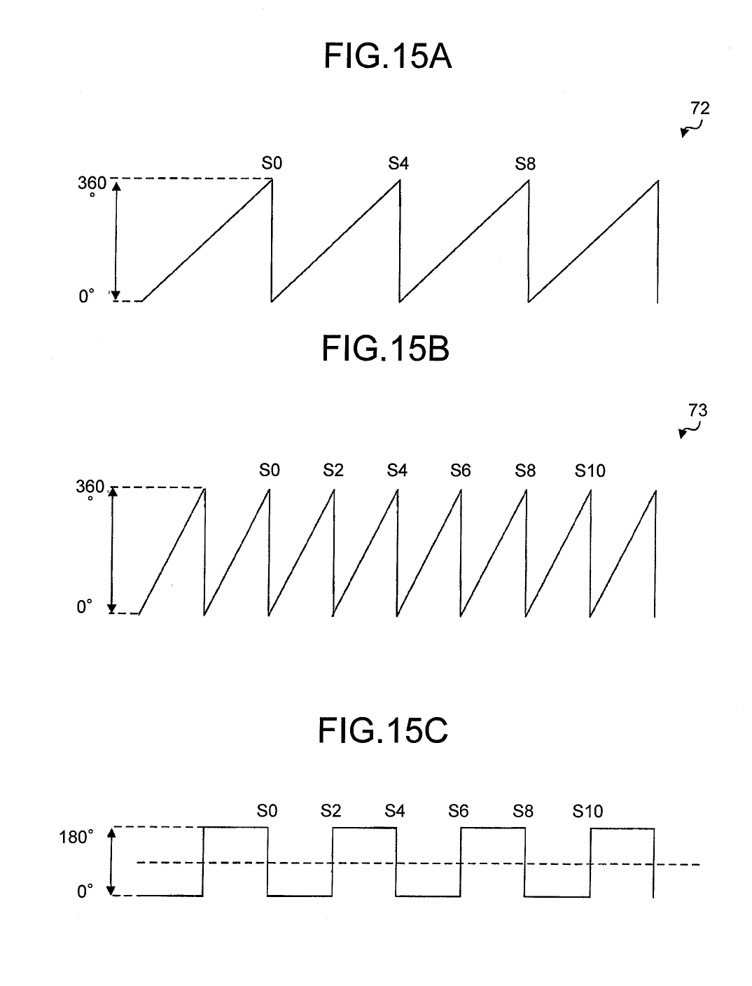

The first synthesis is explained using angles calculated by the demodulations with reference to FIGS. 15A to 15C. In FIG. 15A, 72 denotes a value obtained by representing the vector calculated by the odd demodulation by the angle. In FIG. 15B, 73 denotes a value obtained by representing the vector calculated by the fine demodulation by the angle. S0 to S10 illustrated in FIGS. 15A to 15C denote the cylinder numbers. An angle 72 becomes 360° by four cylinders and an angle 73 becomes 360° by two cylinders. If the angle 73 is subtracted from the angle 72, as illustrated in FIG. 15C, each cylinder can be illustrated by the two angles of 0° and 180°. By the first synthesis, since unwanted angles other than 0° and 180° are removed, the position of the target cylinder can be detected with precision in the range of ±2 cylinders.

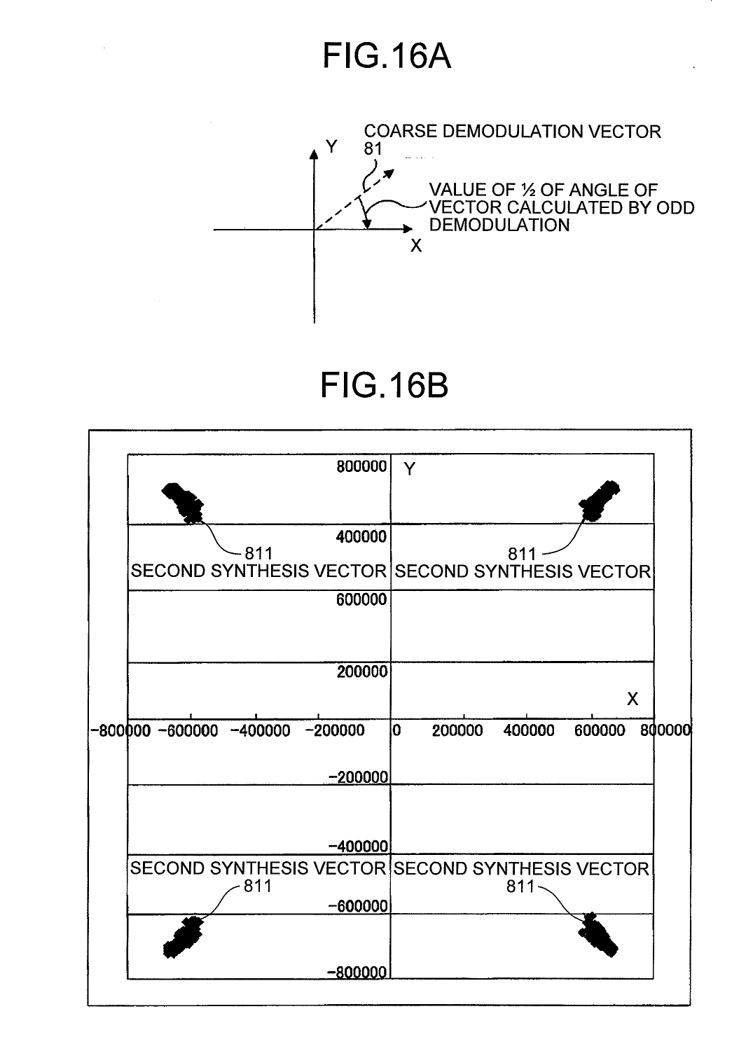

The second synthesis is explained using the vectors calculated by the demodulations with reference to FIGS. 16A and 16B. As illustrated in FIG. 16A, the processor 503 sets a value of ½ of an angle of the vector calculated by the odd demodulation or a value of ¼ of an angle of the vector calculated by the fine demodulation as a rotation operator and rotates a coarse demodulation vector 81 calculated by the coarse demodulation using the rotation operator. Thereby, as illustrated in FIG. 16B, a judging method using four quadrature vectors that separates the coarse demodulation vector 81 into vectors in four quadratures of 45°, 135°, −45°, and −135° is enabled. In FIG. 16B, a state where the second synthesis is performed a plurality of times is illustrated. In a second synthesis vector 811 obtained as the result of the second synthesis, angle differences exist in each quadrature. This is because errors are generated in the angles of the second synthesis vector 811, even though the second synthesis is performed. However, even though the errors are generated, since the coarse demodulation vector 81 is separated into angles approximated to 45°, 135°, −45°, and −135°, the position of the target cylinder can be detected with precision in a range of ±8 cylinders.

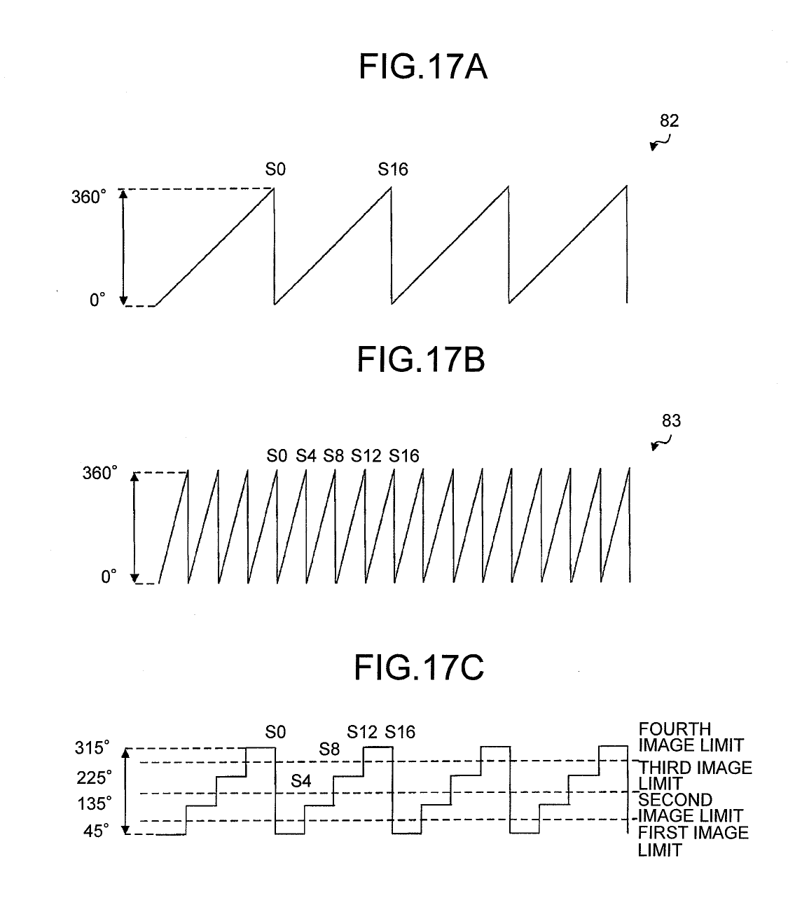

The second synthesis is explained using angles calculated by demodulations with reference to FIGS. 17A to 17C. In FIG. 17A, 82 denotes a value obtained by representing the vector calculated by the coarse demodulation by the angle. In FIG. 17B, 83 denotes a value obtained by representing the vector calculated by the odd demodulation by the angle. S0 to S16 illustrated in FIGS. 17A to 17C denote the cylinder numbers. An angle 82 becomes 360° by sixteen cylinders and an angle 83 becomes 360° by four cylinders. If the angle 83 is subtracted from the angle 82, as illustrated in FIG. 17C, each cylinder can be illustrated by the four angles of 45°, 135°, 225° or −135°, and 315° or −45°. By the second synthesis, since unwanted angles other than 45°, 135°, −45°, −135° are removed, the position of the target cylinder can be detected with precision in the range of ±8 cylinders.

According to the first synthesis and the second synthesis, since the judging method using two quadrature vectors and the judging method using four quadrature vectors are used to detect the position of the target cylinder in the range of ±2 cylinders and the range of ±8 cylinders, calculations of a plurality of times using an arc tan function do not need to be performed. As a result, load on the CPU 554 can be reduced.

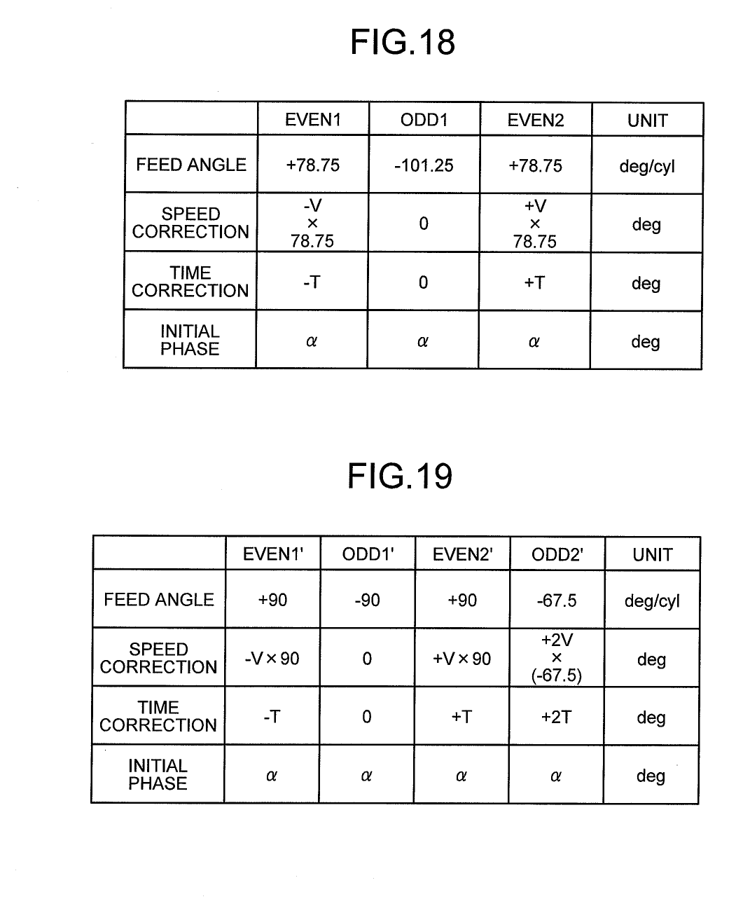

In the embodiment, the synthesizing process of S104 is executed after the demodulating process of S103 is executed. However, the first synthesis may be performed after the odd demodulation in the demodulating process. In the embodiment, the feed angle of each position area is the feed angle illustrated in FIG. 3. However, as illustrated in FIG. 18, the values of the position areas even1, even2 and the value of the position area odd1 may be replaced.

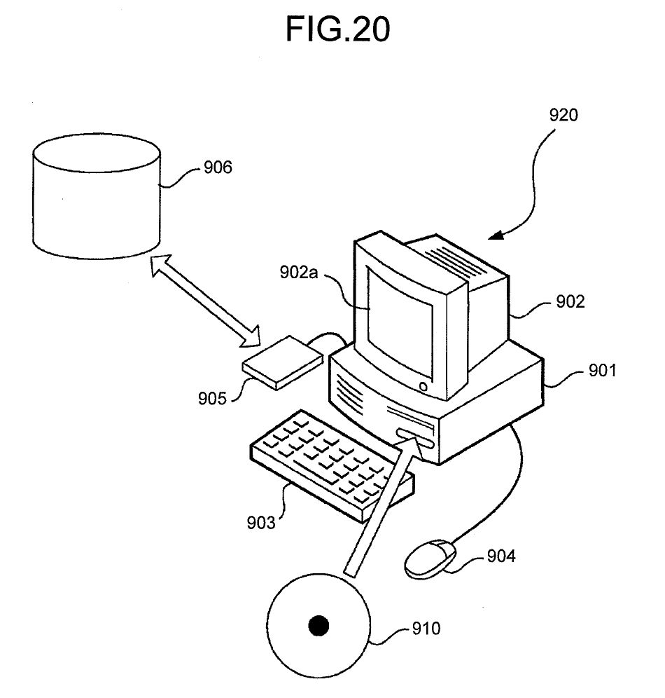

As a comparative example, position areas of a storage medium to which the technology disclosed in the present application is not applied will be described. FIG. 19 is an exemplary view of position areas of the storage medium to which the technology disclosed in the present application is not applied. As illustrated in FIG. 19, unlike the storage medium 1 in the embodiment, the storage medium in the comparative example has a position area odd2. For this reason, in the storage medium in the comparative example, the width of the servo pattern is wider than that of the storage medium 1, and a storage area of the user data is narrowed. In addition, operations of the speed correction and the time correction need to be performed on the position area odd2. As a result, in the storage medium in the comparative example, the load on the CPU 554 is larger than that of the storage medium 1.

Meanwhile, according to the embodiment, since the position of the target cylinder is detected using the three position areas, the length of the servo pattern can be decreased. Consequently, the storage capacity of the user data can be increased. In the storage medium in the comparative example, even though the demodulation is performed based on three position areas of even1′, odd1′, and even2′, the position of the target cylinder cannot be detected in the range of ±8 cylinders. Meanwhile, according to the embodiment, if the position of the target cylinder is detected using the three position areas, the position of the target cylinder can be detected in the range of ±8 cylinders. According to the embodiment, the position of the target cylinder can be detected in the range of ±1 cylinder and the range of ±2 cylinders.

The technology disclosed in the present application can be applied to a computer system to be described below. FIG. 20 is an exemplary view of a computer system where the technology disclosed in this application is applied. A computer system 920 illustrated in FIG. 20 has a main body 901 where a CPU or a hard disk drive is embedded, a display 902 that displays an image according to an instruction from the main body 901, a keyboard 903 that is used to input a variety of information to the computer system 920, a mouse 904 that is used to designate an arbitrary position on a display screen 902a of the display 902, and a communication device 905 that has access to an external database and downloads a program stored in another computer system. The communication device 905 may be a network communication card or a modem.

In the computer system that constitutes the storage device having the storage medium 1, a program for executing the steps above mentioned can be provided as a track position detecting program. This program can be stored in a storage medium that is readable by the computer system and can be executed by the computer system that constitutes the storage device having the storage medium 1. The program for executing the steps is stored in a portable storage medium such as a disk 910 or downloaded from a storage medium 906 of another computer system through the communication device 905. A track position detecting program (or track position detecting software) that causes the computer system 920 to have at least a track position detecting function is input to the computer system 920 to be compiled. This program causes the computer system 920 to be operated as a storage device having the track position detecting function. This program may be stored in a computer readable storage medium such as the disk 910.

Examples of the storage medium that is readable by the computer system 920 comprise an internal storage device embedded in a computer such as a ROM or a RAM, the disk 910 or a flexible disk, a DVD disk, a magneto-optical disk, a portable storage medium such as an IC card, a database storing a computer program, another computer system and a database thereof, and various storage media that can be accessed by a computer system connected through a communication module such as the communication device 905.

Position information corresponds to the position 114 and a predetermined angle corresponds to +11.25° or −11.25°. A first pattern corresponds to the position area even1, a second pattern corresponds to the position area odd1, and a third pattern corresponds to the position area even2. A first range corresponds to the range of ±1 cylinder and a second range corresponds to the range of ±8 cylinder.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage medium configured to store position information indicating positions of a plurality of tracks in a radial direction in the tracks, wherein the position information comprises:
a first pattern in which a feed angle indicating a phase difference between the tracks is obtained by adding a predetermined angle to +90°;
a second pattern in which the feed angle is obtained by adding the predetermined angle to −90°; and
a third pattern in which the feed angle is the same as the feed angle of the first pattern.

2. The storage medium of claim 1, wherein dithering is applied to the first pattern, the second pattern, and the third pattern in such a manner that a position of the track calculated based on phases of the first pattern, the second pattern, and the third pattern is substantially the same as an actual track position corresponding to the calculated track position.

3. The storage medium of claim 1, wherein a phase difference between a phase of the first pattern or the third pattern and a phase of the second pattern indicates a position of the track in the radial direction in a first range of a predetermined number of tracks, and a phase difference between the phase of the first pattern or the third pattern and a phase in which a polarity of the second pattern is reversed or a phase difference between a phase in which a polarity of the first pattern or the third pattern is reversed and the phase of the second pattern indicates a position of the track in the radial direction in a second range wider than the first range.

4. The storage medium of claim 1, wherein a difference between the feed angle of each of the first pattern and the third pattern and the feed angle of the second pattern is +180°, and a sum of the feed angle of each of the first pattern and the third pattern and the feed angle of the second pattern is −22.5° or +22.5°.

5. The storage medium of claim 1, wherein the predetermined angle is +11.25° or −11.25°.

6. A track position detecting method of a storage medium configured to store position information indicating positions of a plurality of tracks in a radial direction in the tracks, the track position detecting method comprising:
acquiring first phase information from a first pattern of the position information in which a feed angle indicating a phase difference between the tracks is obtained by adding a predetermined angle to +90°;
acquiring second phase information from a second pattern of the position information in which the feed angle is obtained by adding the predetermined angle to −90°;
acquiring third phase information from a third pattern of the position information in which the feed angle is the same as the feed angle of the first pattern; and
demodulating the first, second, and third phase information in order to detect a position of the track.

7. The track position detecting method of claim 6, wherein
the position of the track in the radial direction in a first range of a predetermined number of tracks is detected based on the demodulation of the first phase information or the third phase information and the second phase information, and
the position of the track in the radial direction in a second range wider than the first range is detected based on the demodulation of the first phase information or the third phase information and information in which a polarity of the second phase information is reversed, or the demodulation of information in which a polarity of the first phase information is reversed or information in which a polarity of the third phase information is reversed and the second phase information.

8. The track position detecting method of claim 6, wherein the demodulation using the first phase information, the second phase information, and the third phase information comprises:
fine demodulation to calculate a phase difference between the first phase information or the third phase information and the second phase information as a first vector;
odd demodulation to calculate a second vector by performing predetermined correction on the second phase information; and
coarse demodulation to calculate a phase difference between the first phase information or the third phase information and information in which a polarity of the second phase information is reversed or a phase difference between information in which a polarity of the first phase information is reversed or information in which a polarity of the third phase information is reversed and the second phase information as a third vector.

9. The track position detecting method of claim 8, wherein the predetermined correction uses at least one of the third vector, a gray code in the position information, and an estimation position indicating an estimated position of the track from which the first phase information, the second phase information, and the third phase information are acquired.

10. The track position detecting method of claim 8, wherein a ½ value of an angle in the first vector is used as a first rotation operator, and the second vector is rotated using the first rotation operator.

11. The track position detecting method of claim 8, wherein a ½ value of an angle in the second vector or a ¼ value of an angle in the first vector is used as a second rotation operator, and the third vector is rotated using the second rotation operator.

12. A computer program product having a computer readable medium including programmed instructions for detecting a track position of a storage medium configured to store position information indicating positions of a plurality of tracks in a radial direction in the tracks, wherein the instructions, when executed by a computer, cause the computer to perform:
acquiring first phase information from a first pattern of the position information in which a feed angle indicating a phase difference between the tracks is obtained by adding a predetermined angle to +90°;
acquiring second phase information from a second pattern of the position information in which the feed angle is obtained by adding the predetermined angle to −90°;
acquiring third phase information from a third pattern of the position information in which the feed angle is the same as the feed angle of the first pattern; and
demodulating the first, second, and third phase information to detect a position of the track.

13. The computer program product of claim 12, wherein the position of the track in the radial direction in a first range of a predetermined number of tracks is detected based on the demodulation of the first phase information or the third phase information and the second phase information, and the position of the track in the radial direction in a second range wider than the first range is detected based on the demodulation of the first phase information or the third phase information and information in which a polarity of the second phase information is reversed, or the demodulation of information in which a polarity of the first phase information is reversed or information in which a polarity of the third phase information is reversed and the second phase information.

14. The computer program product of claim 12, wherein the demodulation of the first phase information, the second phase information, and the third phase information comprises:
fine demodulation to calculate a phase difference between the first phase information or the third phase information and the second phase information as a first vector;
odd demodulation to calculate a second vector by performing predetermined correction on the second phase information; and
coarse demodulation to calculate a phase difference between the first phase information or the third phase information and information in which a polarity of the second phase information is reversed or a phase difference between information in which a polarity of the first phase information is reversed or information in which a polarity of the third phase information is reversed and the second phase information as a third vector.

15. The computer program product of claim 14, wherein the predetermined correction is configured to use at least one of the third vector, a gray code in the position information, and an estimation position indicating an estimated position of the track from which the first phase information, the second phase information, and the third phase information are acquired.

16. The computer program product of claim 14, wherein a ½ value of an angle in the first vector is used as a first rotation operator, and the second vector is rotated using the first rotation operator.

17. The computer program product of claim 14, wherein a ½ value of an angle in the second vector or a ¼ value of an angle in the first vector is used as a second rotation operator, and the third vector is rotated using the second rotation operator.
